(19) United States
(12) Patent Application Publication
(10) Pub. No.: US 2007/0263784 A1
(43) Pub. Date: Nov. 15, 2007

(54) AUTOMATED VOICE ANSWERING SYSTEM CORRELATED TO USER CALENDAR TO PROVIDE TELEPHONE VOICE RESPONSES BASED UPON USER SCHEDULE

(76) Inventors: Thomas Richard Forrer JR., Round Rock, TX (US); Jason E. Moore, Austin, TX (US); Asghar Tavasoli, Austin, TX (US); Abel Enrique Zuzuarregui, Paige, TX (US)

Correspondence Address: IBM CORPORATION;INTELLECTUAL PROPERTY LAW, 11400 BURNET ROAD, AUSTIN, TX, 78758, US

(21) Appl. No.: 11/279,126

(22) Filed: Apr. 10, 2006

(51) Int. Cl. H04M 1/64

(52) U.S. Cl. 379/67.1

(57) ABSTRACT

A telephone answering system associated with a telephone receiving terminal, either wired or mobile wireless, including an implementation for predetermining a set of different types of incoming telephone calls; the type of calls may be based on who the caller is and/or based upon the identifier of the incoming call. This is combined with a calendar listing time of day segments of the schedule of the recipient of an incoming telephone call. Storage is provided for a set of different vocal responses, for each time segment, to each of said set of different types of telephone calls. Then, responsive to an incoming call, there is provided the appropriate stored vocal for the type of said incoming call based upon the type or nature of the caller and the recipient's calendar.

### TECHNICAL FIELD

The present invention relates to telecommunications systems and particularly to automated telephone voice answering systems

### BACKGROUND OF RELATED ART

With the globalization of business, industry and trade wherein transactions and activities within these fields have been changing from localized organizations to diverse transactions over the face of the world, the telecommunications industries have, accordingly, been expanding rapidly.

In order to maximize productivity of the working staffs of a variety of business, government and educational facilities, the answering of incoming telephone calls has become more and more automated. It is not unusual for a telephone caller to an organization to go through five or more iterations to finally reach the appropriate person or function only to have the call answered by a machine, i.e. automated voice answering. While many automated voice answered telephones may have not been as frustrating to the user, there have been many incidents of automated voice responses that have been even more frustrating. The same frustration on the part of the personal or home user calling friends, relatives, shops or community functions is becoming more and more apparent. In conclusion, there can be little doubt that “voice mail” or the telephone answering function has become a great source of frustration for telephone callers. There have been countless incidents of people and organizations changing their vendors and other business associates because of dissatisfaction with telephone voice answering procedures of such organizations.

In the achievement of good business and personal relationships, there is no wholly satisfactory substitute for personally answering telephone calls. However, because of the increase in productivity of the overall business or like organization contributed to by automated voice answering of incoming telephone calls, it is the rare organization that considers returning to a completely personal answering system. Consequently, organizations have been seeking efficient telephone voice answering systems that will be more efficient from the overall organization view and minimize caller frustrations.

### SUMMARY OF THE PRESENT INVENTION

The present invention offers one solution to the problems of increasing automated telephone voice answering efficiency and minimizing caller irritation. The invention stems from the understanding that a bare voice message with minimal information about the status of the call recipient is very frustrating to the caller, particularly a caller who may have already “pressed” his way through several iterations to finally get to the recipient. In order to provide a more meaningful voice message, this invention utilizes two automatable systems that may respectively provide: 1) information about the caller, i.e. caller identification, coordinated with; 2) the recipient's calendar that may be already automated on the user's computer system for other purposes.

Accordingly, the invention provides a telephone answering system associated with a telephone receiving terminal, either wired or mobile wireless, including an implementation for predetermining a set of different types of incoming telephone calls; the type of call may be based on who the caller is and/or upon the identifier of the incoming call, e.g. the recipients boss, an important business associate, doctor, child or wife, etc. This is combined with a calendar, listing the time of day segments of the schedule of the recipient of an incoming telephone call. Storage is provided for a set of different vocal responses, for each time segment, to each of said set of different types of telephone calls. Then, responsive to an incoming call, there is provided the appropriate stored vocal for the type of said incoming call, based upon the type or nature of the caller and the recipient's calendar.

While the stored responses may be considered predetermined default responses, the user, i.e. potential call recipient, is enabled to override any selected predetermined response with a response that the user deems appropriate for any particular time and circumstances.

In addition to the stored responses in any time segment, the user is enabled to include a call forwarding implementation for transferring the incoming call to another receiving terminal.

The type of incoming call may be determined by an identifier associated with the telephone call or by the content of the incoming telephone call.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a generalized diagrammatic view of portions of PSTN (Public Service Telephone Networks) public telephone and IP (Internet Protocol) telecommunications networks on which the present invention may be implemented;

FIG. 2 is a block diagram of a generalized display computer system including a processor unit that may perform the functions of the display computers through which the calendar supported voice answering to either PSTN or IP telecommunications may implemented; the computer system is also representative of either PSTN or IP servers that may perform such functions;

FIG. 3 is a flowchart describing how the automated telephone voice answering process of the present invention may be set up; and

FIG. 4 is a simplified flowchart example of the processing of an incoming telephone call may be responded to using the process set up in FIG. 3.

### DETAILED DESCRIPTION OF THE PREFERRED EMBODIMENT

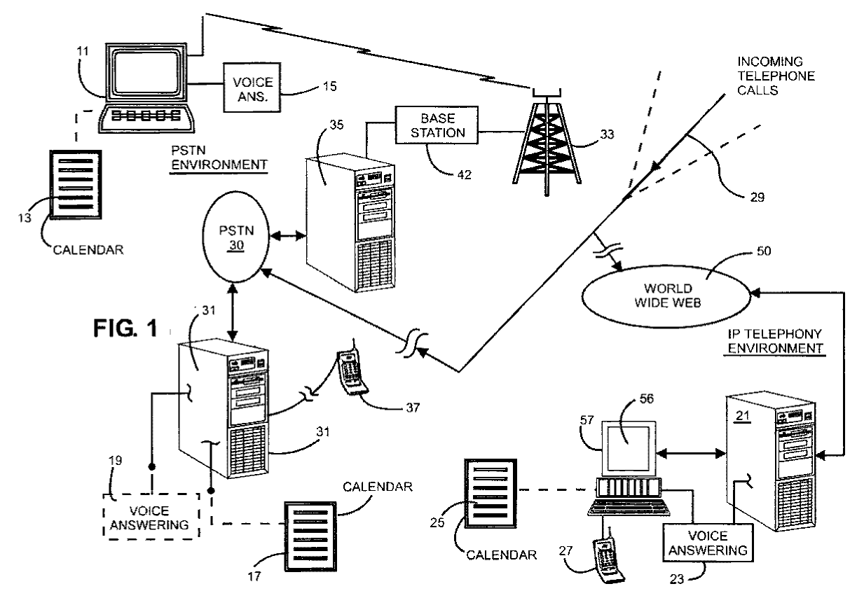

Referring to FIG. 1, there is shown a generalized diagrammatic view of portions of PSTN and IP telecommunications environments. The present invention is applicable to telephone voice answering in both the traditional PSTN and the more recent IP telephony environments. Some illustrative Voice Mail systems usable in the present invention are described in the Text IP Telephony Demystified, Ken Camp, published 2003, McGraw-Hill, New York, pp. 222-223. Similarly, illustrations of voice mail answering in a PSTN environment may be found in Newton's Telecom Dictionary, published 2003, CMP Books, San Francisco at page 869.

The PSTN network includes channel paths to and from both conventional wired and mobile wireless channels and cellular devices. Cellular telephone device 11 is representative of the many current mobile cellular telephones that include extensive data processing functions. These telephone devices include Personal Digital Assistant (PDA) devices. Such devices 11 may include both the calendar 13 and voice answering 15 functions that will be hereinafter described in greater detail. The cellular devices, i.e. PDAs, 11 are in regions within the range of the cellular area set up as represented by cell tower 33 connected to a cell base station 42 that in turn is connected to switching center 35 that then routes the telecommunications into PSTN 30 to which conventional hardwired telephone terminals as represented by telephone 37 are connected. The telephone 37 is typical of the conventional telephones that may be used in the practice of this invention. Telephone 37 may have its own associated computer on which either or both of the voice answering and calendar functions may be implemented. Alternatively, as shown in FIG. 1, the telephone 37 may be connected to a server system 31 that may be maintained by a telephone service provider, providing either or both of the voice answering 19 and calendar 17 functions. Server 31 is connected to the PSTN 30 that processes and distributes the incoming telephone calls 24 that the present invention is handling. Using the programs of the present invention, to be subsequently described, any standard calendaring system may be used to perform the required functions. One such known calendaring system is described in U.S. Pat. No. 5,500,938 issued Mar. 19, 1996.

Similarly, in the IP telephony environment, the incoming telephone calls 24 are appropriately distributed via the Web 50 through Web Server 21. In this arrangement the IP telephone 27 is connected through associated display 56 computer 57 and server 21 to Web 50. The calendar 25 is usually supported on the associated computer 57 although the calendar for telephone 27 may also be maintained and supported on server 21. The voice answering function 23 may be supported on the associated computer 57 or on the Web server 21. In the computer 57, for example, the calendar function 25 would create text streams using the open standard: VoiceXML. This is a platform independently structured language using the extensive markup language (XML) standard specification to deliver voice content through the Web or the conventional telephone systems. The VoiceXML provides the framework for recognizing user input and recording user input. A VoiceXML document is composed of text elements and tags that may be interpreted and used to drive conventional voice synthesizers. VoiceXML is described in greater detail in the above-mentioned Newton's Telecom Dictionary at page 871.

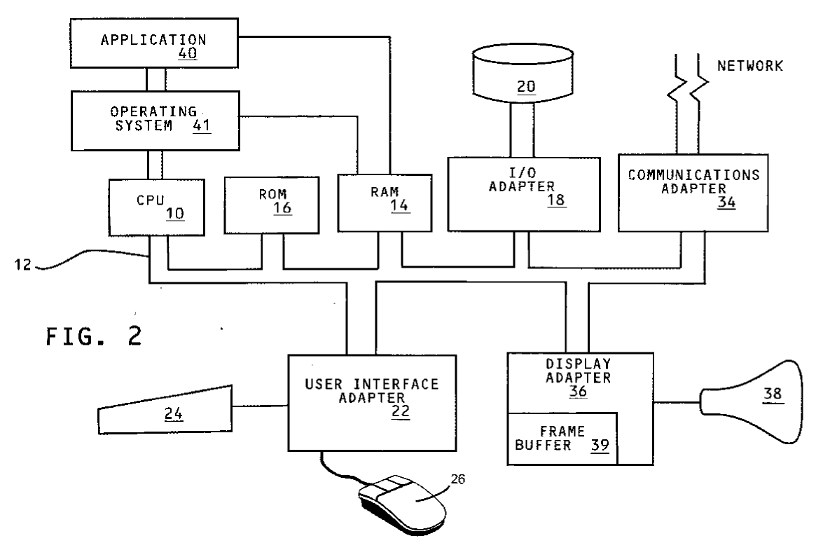

Referring to FIG. 2, a typical data processing system is shown that may function as computer 57, or the telephone server 31 or the IP Web server 21. A central processing unit (CPU) 10, may be one of the commercial microprocessors in personal computers available from the Lenovo Company or Dell Corporation; when the system shown is used as a server computer for the Web or PSTN, then a workstation is preferably used, e.g. RISC System/6000™ (RS/6000) series available from IBM. The CPU is interconnected to various other components by system bus 12. An operating system 41 runs on CPU 10, provides control and is used to coordinate the function of the various components of FIG. 1. Operating system 41 may be one of the commercially available operating systems such as the AIX 6000™ operating system available from IBM; Microsoft's Windows XP™ or Windows2000™, as well as UNIX and other IBM AIX operating systems. Application programs 40, controlled by the system, are moved into and out of the main memory Random Access Memory (RAM) 14. These programs include the programs of the present invention for coordinating calendar and voice answering functions. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with the outside network enabling the computer system to communicate with other such computers over the Web or Internet. In the IP environment, the incoming telephone calls are received through the communication adapter in computer 57. I/O devices are also connected to system bus 12 via user interface adapter 22 and display adapter 36. Keyboard 24 and mouse 26 are all interconnected to bus 12 through user interface adapter 22. It is through such input devices that the user at a receiving telephone terminal 57 may interactively relate to the computer. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like.

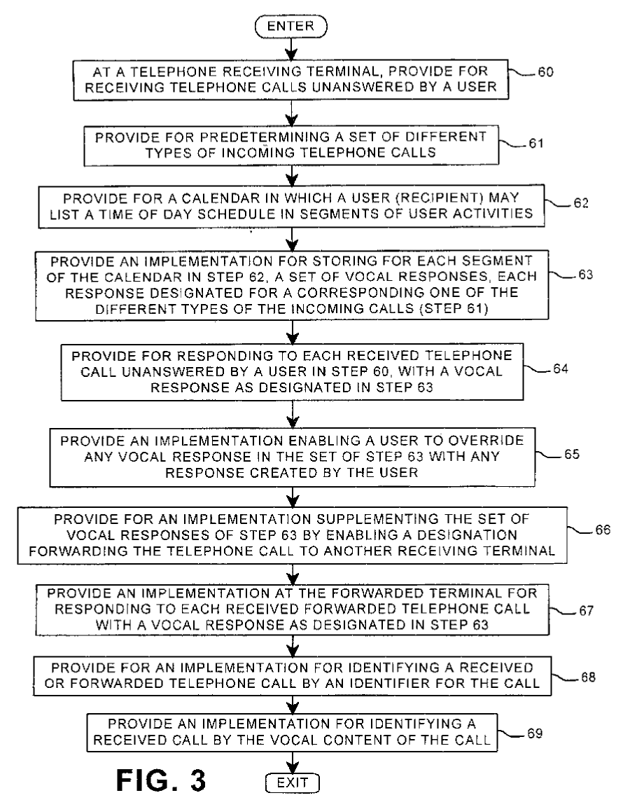

FIG. 3 is a flowchart showing the development of a system according to the present invention for automated telephone answering, coordinating the recipient's calendar of time of day listings with a voice answering routine providing a predetermined automated vocal response tailored for the identified caller and selected from a set of stored responses. Provision is made for the automated answering of telephone calls unanswered by the user/recipient of the telephone terminal, e.g. receiving telephone, step 60. Provision is made for predetermining a group or set of different types or categories of anticipated incoming calls that would require different responses from the recipient, step 61. This, of course, requires that the caller or the nature of the call be identified. Particular techniques for identification will be discussed hereinafter. Some examples of types or categories of calls include: particular people, e.g. family members, doctors, business associates, unknown callers. The nature of the call may also be a category, e.g. second or third calls from the same caller. An answering system could readily be modified to count the personally unanswered repeats of the same caller. In such a case, perhaps a stored message giving more details as to the recipient's status may be appropriate. Another “nature of the call” may be unrequested intrusive calls from telephone marketers.

Provision is made for the availability of a calendar of the call recipient that lists the time of day schedule of the recipient in segments of the recipient's (user's) activities, step 62. Provision is made for storing, step 63, for each segment of the calendar of step 62, a set of vocal responses, each response designated for a corresponding one of the different types or categories of incoming calls in step 61.

### EXAMPLE

### For 11-11:30 AM

| ID'ed Caller | Response |
|---|---|
| Family | Bob is in a meeting |
| Boss | Bob is in Finance Meeting (Rm. 101) |
| Unknown | Bob is away from his desk |

Provision is made for a vocal response, step 64, to each received telephone call unanswered by a user in step 60, which response is appropriate to the designations set up in step 63.

Another implementation permits the recipient/user to override any vocal response in the stored set of step 63, and substitute another response appropriate to specific circumstances, step 65.

Provision may also be made for an implementation that supplements the set of stored vocal responses with a selection enabling a response to an identified type of call that forwards the call to another telephone terminal, step 66. Further provision is made at the forwarded to telephone terminal, step 67, for responding to each received forwarded telephone call with an appropriate vocal response as designated in step 63.

Provision is made for identifying the received telephone call through the identifier, e.g. the IP identifier or the caller's telephone number for calls from PSTN locations, step 68. The call may also be identified by the call's content, step 69. The terminology of the telephone call's content may be recognized by any conventional speech recognition technique, e.g. those described in U.S. Pat. No. 5,671,328 or U.S. Pat. No. 5,664,061. Also, since received IP calls may be in the form of XML text streams, the call's content could be reduced to a text form. In such cases, even if the telephone call ID is unknown, it would be possible to interpret the content by automated interpretive implementations to decide the category of the call, e.g. from a telemarketer, etc.

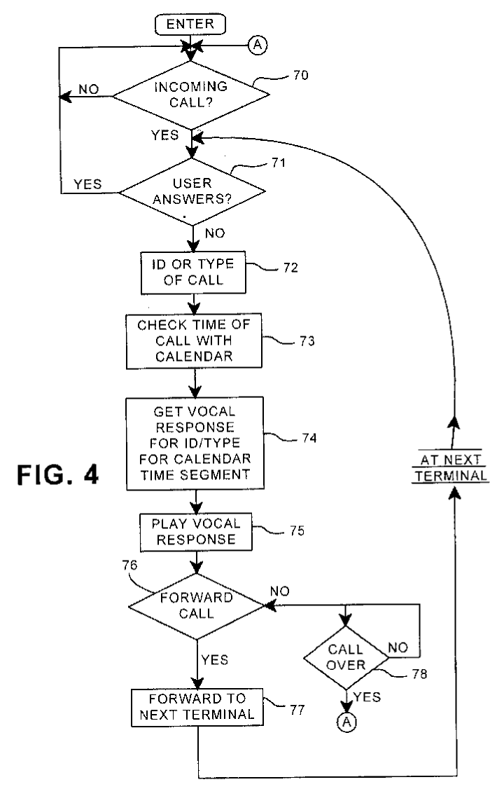

A simplified illustrative run of the process set up in FIG. 3 and described in connection with FIG. 1 will now be described with respect to the flowchart of FIG. 4. An incoming telephone call is awaited at the recipient's telephone terminal, step 70. If Yes, a telephone call is received, then, step 71, a further determination is made as to whether the user/recipient has answered the call. If Yes, the vocal answering is not necessary and the process is returned to step 70 where a next call is awaited. If No, the call is not answered, then the ID is determined, and the type of call is determined from the ID or otherwise, step 72. Then, the recipients calendar is checked for the time segment within which the call was received, step 73. The stored vocal response for the time is obtained based upon the identified or interpreted type of received telephone call, step 74, and the appropriate vocal response is output to the caller, step 75. In any event, a further check is made as to whether a call forwarding option has been preselected by the user/recipient for the calendar time segment and the type of call, step 76. If Yes, the call is forwarded to the designated receiving terminal, step 77, and at this next terminal, the above-described answering process of this invention is commenced by returning the process to step 71 for the forwarded call at this next terminal. If there is a No decision from step 76, i.e. no forwarding, then the end of the current call is awaited, step 78. When Yes, the call is over, then the process returns via branch “A” to step 70 where a next telephone call is awaited.

One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

What is claimed is:

1. An automated telephone voice answering system associated with a receiving terminal comprising:
means for receiving an incoming telephone call;
means for predetermining a set of different types of incoming telephone calls;
a calendar listing time of day segments of the schedule of the recipient of an incoming telephone call;
means for storing, for each time segment, a set of vocal responses to each of said set of different types of telephone calls; and
means responsive to said incoming call for providing said stored vocal response to said type of said incoming call.

2. The telephone answering system of claim 1 wherein:
said set of vocal responses are default responses; and
further including means enabling a user to override at least one of vocal responses with another vocal message.

3. The telephone answering system of claim 1 wherein said set of responses further includes means for forwarding said incoming telephone call to another receiving terminal.

4. The telephone answering system of claim 3 wherein said another receiving terminal comprises:
means for receiving said forwarded telephone call;
means for predetermining a set of different types of incoming telephone calls;
a calendar listing time of day segments of the schedule of the recipient of an incoming telephone call;
means for storing, for each time segment, a set of vocal responses to each of said set of different types of telephone calls; and
means responsive to said forwarded call for providing said stored vocal response to said type of forwarded call.

5. The telephone answering system of claim 1 wherein the type of an incoming call telephone is determined by an identifier associated with the telephone call.

6. The telephone answering system of claim 1 wherein the type of an incoming call telephone is determined by the content of the incoming telephone call.

7. The telephone answering system of claim 1 wherein said calendar and said means providing said vocal response is in the same receiving terminal device.

8. A method for automated telephone voice answering associated with a receiving location comprising:
receiving an incoming telephone call;
predetermining a set of different types of incoming telephone calls;
listing time of day segments of the schedule of the recipient of an incoming telephone call in a calendar;
storing, for each time segment, a set of vocal responses to each of said set of different types of telephone calls; and
providing said stored vocal response to said type of said incoming call in response to said incoming call.

9. The method of claim 8 wherein:
said set of vocal responses are default responses; and
further including the step of enabling a user to override at least one of said vocal responses with another vocal message.

10. The method of claim 8 wherein said set of responses further includes the response of forwarding said incoming telephone call to another receiving location.

11. The method of claim 10 comprising the steps at said another receiving location of:
receiving said forwarded telephone call;
predetermining a set of different types of incoming telephone calls;
listing time of day segments of the schedule of the recipient of an incoming telephone call in a calendar;
storing, for each time segment, a set of vocal responses to each of said set of different types of telephone calls; and
providing said stored vocal response to said type of said incoming call in response to said forwarded call.

12. The method of claim 8 wherein the type of an incoming telephone call is determined by an identifier associated with the telephone call.

13. The method of claim 8 wherein the type of an incoming telephone call is determined by the content of the incoming telephone call.

14. A computer program having code recorded on a computer readable medium for automated telephone answering at a receiving telephone location comprising;
means for receiving an incoming telephone call;
means for predetermining a set of different types of incoming telephone calls;
a calendar listing time of day segments of the schedule the recipient of an incoming telephone call;
means for storing, for each time segment, a set of vocal responses to each of said set of different types of telephone calls; and
means responsive to said incoming call for providing said stored vocal response to said type of said incoming call.

15. The computer program of claim 14 wherein:
said set of vocal responses are default responses; and
further including means enabling a user to override at least one of said vocal responses with another vocal message.

16. The computer program of claim 14 wherein said set of responses further includes means for forwarding said incoming telephone call to another receiving location.

17. The computer program of claim 16 wherein said another receiving location comprises:
means for receiving said forwarded telephone call;
means for predetermining a set of different types of incoming telephone calls;
a calendar listing time of day segments of the schedule of the recipient of an incoming telephone call;
means for storing, for each time segment, a set of vocal responses to each of said set of different types of telephone calls; and
means responsive to said forwarded call for providing said stored vocal response to said type of forwarded call.

18. The computer program of claim 14 wherein the type of an incoming telephone call is determined by an identifier associated with the telephone call.

19. The computer program of claim 14 wherein the type of an incoming telephone call is determined by the content of the incoming telephone call.

20. The telephone answering system of claim 1 wherein said calendar and said means providing said vocal response are in the same call receiving device.
